(19) United States
(12) Patent Application Publication
(10) Pub. No.: US 2026/0268529 A1
(43) Pub. Date: Sep. 10, 2026

(54) LEARNING-BASED GAUSSIAN SPLATTING CODING

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 19/071,143

(22) Filed: Mar. 5, 2025

(51) Int. Cl. G06T 9/00

(52) U.S. Cl. CPC G06T 9/001

(57) ABSTRACT

Encoding and decoding systems and methods for 3D Gaussian splatting (3DGS). An example encoding method comprises: obtaining input 3D Gaussian splatting information including location information, first attribute information, and second attribute information; encoding the location information in a bitstream; encoding the first attribute information in the bitstream with a dependency on the location information; making a determination of whether to encode the second attribute information with a dependency on the first attribute information; encoding the second attribute information in the bitstream according to the determination, the second attribute information being encoded with a dependency on the location information; and signaling an indication of the result of the determination in the bitstream.

### BACKGROUND

This disclosure relates to the field of 3D reconstruction and rendering. In particular, this disclosure relates to 3D Gaussian Splatting (3DGS). This field aims to develop tools for compression, analysis, interpolation, representation and understanding of 3D Gaussian Splatting. Novel View Synthesis (NVS) is a computer graphics task aimed at generating images of scenes or objects from previously unseen viewpoints. This capability is useful for applications in virtual reality, augmented reality, 3D reconstruction, and gaming. The 3D Gaussian Splatting (3DGS) framework is useful for novel view synthesis. By using 3D Gaussians as primitives, 3DGS effectively represents both the geometry and texture of a 3D scene, modeling it as a collection of 3D Gaussians defined by their mean, covariance, opacity, and spherical harmonics to capture view-dependent color. With its highly parallelizable design and advancements in GPU technology, 3DGS achieves significantly faster training and rendering times than the Neural Radiance Field (NeRF) framework.

While 3D Gaussian Splatting achieves fast-rendering visual output, its visual quality could still be further improved. The optimization process of the Gaussian splats is a process that can be described as gradually “overfitting” the 3D scenes with Gaussians. However, due to the ad-hoc and lack-of-constraint optimization of 3D Gaussians from the given multi-view images, this process can result in redundant Gaussians with minimal impact on rendering quality. Additionally, the generated Gaussians may be irregularly scattered in the space. These sub-optimally placed Gaussians have two negative impacts. On one hand, they can harm the visual quality of the rendered novel scene. Moreover, they may harm the performance of the downstream tasks taking the Gaussians as inputs, such as the compression of the Gaussian splats.

### SUMMARY

Briefly stated, in one embodiment, a 3DGS decoding method comprises: decoding 3D Gaussian splatting information from a bitstream including location information and first attribute information; reading from the bitstream an indication of whether second attribute information was encoded with a dependency on the first attribute information; and decoding the second attribute information from the bitstream according to the determination. In some embodiments, the first attribute is in a first group of attributes, the second attribute is in a second group of attributes, and the indication is an indication of whether the second group of attributes was encoded with a dependency on the first group of attributes.

A decoding apparatus according to some embodiments comprises one or more processors configured to perform any decoding method as described herein.

An encoding method according to some embodiments comprises: obtaining input 3D Gaussian splatting information including location information, first attribute information, and second attribute information; encoding the location information and the first attribute information in a bitstream; making a determination of whether to encode the second attribute information with a dependency on the first attribute information; encoding the second attribute information in the bitstream according to the determination; and signaling an indication of the result of the determination in the bitstream. In some embodiments, the first attribute is in a first group of attributes, the second attribute is in a second group of attributes, and the determination is a determination of whether to encode the second group of attributes with a dependency on the first group of attributes.

An encoding apparatus according to some embodiments comprises one or more processors configured to perform any encoding method as described herein.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 is a functional block diagram of an apparatus comprising one or more processors on which example embodiments may be implemented.

FIG. 2A is a flow diagram illustrating creation and updating of Gaussians in a 3DGS system.

FIG. 2B is a flow diagram illustrating the use of a distortion metric in the creation and updating of Gaussians in a 3DGS system.

FIG. 3 is a functional block diagram of a 3DGS encoder according to an example embodiment.

FIG. 4 is a functional block diagram of a 3DGS decoder according to an example embodiment.

FIG. 5 is a functional block diagram of a 3DGS encoder according to another example embodiment.

FIG. 6 is a functional block diagram of a 3DGS decoder according to an example embodiment.

FIG. 7A is a functional block diagram of a conditional encoder as used in some embodiments.

FIG. 7B is a functional block diagram of a conditional decoder as used in some embodiments.

FIG. 8A is a functional block diagram of details of a conditional encoder as used in some embodiments.

FIG. 8B is a functional block diagram of details of a conditional decoder as used in some embodiments.

FIG. 9 is a flow diagram of a 3DGS decoding method according to some embodiments.

FIG. 10 is a flow diagram of a 3DGS encoding method according to some embodiments.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

The present disclosure provides systems and methods for improving the optimization and/or training of Gaussians from the given multi-view images.

For immersive applications, view synthesis technologies are used to display novel views. Depth image-based rendering (DIBR) technologies use depth maps to synthesize novel views based on captured views using hand crafted algorithms. The traditional synthesis DIBR approaches often result in artifacts, often attributable to occlusions between viewing positions.

With recent developments in deep learning, Neural Radiance Fields (NeRF) have been proved to be a remarkable method to synthesize new views of a complex scene from a limited number of captured views. NeRF is described in, for example, Mildenhall et al., “Nerf: Representing scenes as neural radiance fields for view synthesis,” Communications of the ACM 65, no. 1 (2021): 99-106. NeRF can be viewed as an implicit representation of a 3D scene. It uses a neural network with filled parameters to represent a 3D scene. The neural parameters are obtained through a training procedure. In particular, the neural network is intentionally “overfitted” to a particular 3D object or scene. In this way, NeRF often demonstrates a better render quality than traditional DIBR approaches. The improved rendering quality of NeRF may be attributable to the ability of a neural network to “predict” occluded areas better than handcrafted hole filling methods with traditional DIBR. However, unfortunately, computational complexity remains an issue since NeRF aims at evaluating the scene luminance for all the points of the 3D volume.

### Overview of 3D Gaussian Splatting

3D Gaussian Splatting is a technology that potentially maintains the quality of view synthesis of NeRF but with a lower computational complexity. It can efficiently represent and render 3D scenes. An overview of Gaussian Splatting is provided in Kerbl et al., “3D Gaussian Splatting for Real-Time Radiance Field Rendering,” ACM Trans. Graph. 42, no. 4 (2023): 139-1. There, 3D Gaussian Splatting was shown to have a rendering speed as fast as point-based rendering techniques, while suppressing many coinciding artifacts. It uses a 3D Gaussian as the primitive to represent the geometry and texture of a 3D scene. Specifically, it models a scene as a set of 3D Gaussians, which are defined by their means, covariances, opacity and spherical harmonics that model their view dependent color, including RGB values.

The 3D Gaussian Splatting format may be understood by comparison to point cloud data. The means of the Gaussians are analogous to point positions. In Gaussian Splatting, each “point” is associated with a new list of attributes not found in traditional point clouds. The covariance, as one type of attribute, together with point positions provide a complete description of surfaces. This contrasts with conventional point clouds where the points are discrete samples on a surface, resulting in an incomplete representation of a surface. In addition to three RGB values, opacity and spherical harmonics (also as point cloud attributes) significantly enhance the rendering quality.

While 3D Gaussian Splatting shares the same projection modeling motivation as the neural radiance field (NeRF) rendering methods, it avoids the need to densely sample points over the rays that project to a novel view. Instead, the 3D Gaussians are directly projected into the image plane as 2D splats. This avoids unnecessary computation in the empty space, thereby reducing the training time and allowing for real-time rendering. Moreover, with the use of a differentiable projection and rasterization step, the Gaussian parameters can be optimized with a simple supervision in the 2D domain rather than in 3D domain. For example, the optimization can be done by minimizing the photometric loss between a rendered image and a ground truth view captured from the scene.

During optimization of the Gaussian parameters, Kerbl et al. designed a highly efficient tile-based rasterizer that allows for alpha-blending of anisotropic splats while respecting the order of the Gaussians in the 3D space. Given a set of images and camera positions, this allows for fitting the 3D representation of a scene in a few minutes and also allows for the rendering of novel views in real time. However, this optimization process also generates a large number of Gaussians due to a densification process during optimization (cloning and splitting). Furthermore, there are many attributes characterizing each Gaussian. Moreover, the generated Gaussians may be irregularly scattered in the space due to lack of constraint, which may harm the quality of the synthesized view as well as the performance of downstream tasks.

Thus, while 3D Gaussian Splatting (3DGS) is a useful view synthesis technology suitable for rendering objects or scenes that provides advantages in rendering speed and fidelity, 3DGS remains impractical for low resource systems due to its high storage needs. To address this issue, example embodiments make use of a learning-based method to compress 3DGS parameters.

### Overview of 3D Gaussian Splatting

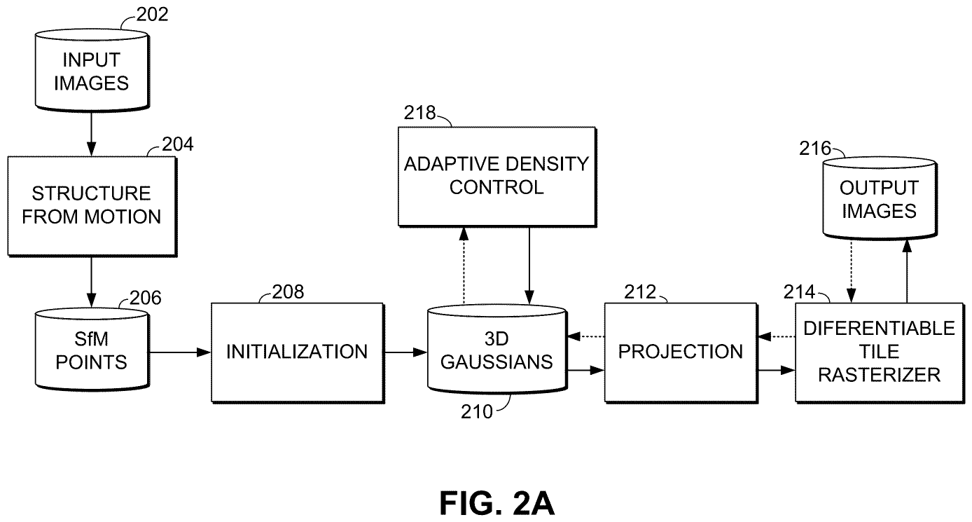

FIG. 2A illustrates a high-level pipeline of how 3D Gaussian Splatting is used. It starts with input images 202 that are captured for an object or a scene. The images can be a sequence of monocular pictures with a possible moving camera or a sequence of multiview pictures.

As a complete geometry representation, a 3D Gaussians representation includes not only point positions (x,y,z) but also shapes, represented by covariances of the Gaussians. The additional covariance parameters are useful in generating a complete representation for geometry as they fill up the “holes” between sampled points. In some implementations, the covariance information is represented using a scaling matrix and a rotation matrix.

Regarding color, each 3D Gaussian is associated with an opacity and with spherical harmonic coefficients that represent color from multiple viewpoints. The following is a brief description of a conventional method of learning 3DGS from the input data.

At 204, a set of structure from motion (SfM) points 206 is generated based on the input images. In an initialization process at 208, the structure from motion points are then used to generate an initial set of 3D Gaussians 210. The positions and color coefficients are directly inherited from the SfM method, and the covariance matrix is initialized as an isotropic Gaussian with axes equal to the mean of the distance to the closest three points.

In a projection process at 212, the position of each 3D Gaussian is projected into an image plane from a camera's perspective, e.g. by applying an affine transformation. After the geometry relationships between 3D points and pixels are established via projection, pixel colors are computed next.

A rasterization process is performed at 214 to generate output images. Rasterization is the process to compute pixel color values based on the 3D Gaussian color attributes. According to the geometry relationship identified in the projection step, the Gaussians are sorted according to depth with Gaussians first that are closer to the camera. For each pixel, an iterative blending process is performed over the sorted Gaussian to render the final color.

At 218, an Adaptive Density Control (ADC) module aims to grow or prune Gaussian primitives. The growth of Gaussian may be done via clone or split of existing Gaussians based on their shape and volume. Gaussians with the opacity less than a predetermined hard threshold may be removed or pruned.

A backward propagation process is used to improve the initial 3D Gaussians provided in the initialization process. In FIG. 2A, the backward propagation process is illustrated with the dashed arrows.

An overview of the backward propagation process is provided in FIG. 2B. As in a training process of a neural network model, an error is computed at 220 by comparing rasterization results providing by the splatting module (FIG. 2A) against a corresponding ground truth image. It implies that the camera viewpoints from ground truth images are chosen to do the projection/rasterization at 213. Based on the pixel-wise error, the associated gradients are computed. These gradients show the direction and magnitude by which the Gaussian parameters are to be updated to minimize the error. The Gaussians are updated at 207 by subtracting the gradients, scaled by a learning rate.

As described above, 3DGS representation of a scene consists of a collection of Gaussians located in the 3D space (the locations being specified by the means of Gaussians), where each Gaussian carries some attributes containing a mix of geometry and color information. In this aspect, 3DGS is related to point clouds, which also consist of points in 3D space (analogous to Gaussians with zero variance) carrying some color information (RGB or reflectance).

In a conventional system for point cloud geometry coding, the point locations are first organized in an octree structure such that the leaf nodes are the original point locations, and the ancestor nodes are obtained through a quantization/downsampling of the current nodes. The coding of the attribute information then makes use of the known geometry information. Each node from the geometry octree is assigned an attribute value such that the original point cloud attributes are the attributes of the leaf nodes of the octree, while the attributes of the ancestor nodes are obtained by averaging the attributes of the child nodes. The goal of the point cloud related geometry and attribute coding is then to compress the respective octree representations, in an overall lossless or lossy manner.

Example embodiments described herein include learning-based end-to-end compression methods and apparatus for 3D Gaussian Splatting.

### Gaussian Spatting Parameters Grouping

In 3DGS, each individual Gaussian is conventionally parameterized by its following parameters:
Mean or location, x∈R³,
Rotation, r∈R⁴,
Scale, s∈R³,
Opacity, α∈R,
Color, c∈R^{k}, where k is the freedom of the spherical harmonic (SH) basis.

The number of spherical harmonic coefficients for each color channel is (L+1)², where L is the highest degree for which coefficients are provided. Typically, L=3 (i.e., 4 bands), making the (3+1)²=16 coefficients per color channel. Out of these 3×16=48 channels, the first 3 are DC components and the remaining 45 are AC components.

In example embodiments, the Gaussian locations x, may be separately coded first by any coding method, such as by a learning-based coding method. Then, for coding the remaining 3DGS parameters, example embodiments organize them in several groups and compress each group via learning-based coding methods. It has been observed that different 3DGS parameters have different sensitivity to quantization, with the parameters listed below (again) in a decreasing sensitivity order:
Mean or location, x∈R³,
Rotation, r∈R⁴,
Scale, s∈R³,
Opacity, α∈R,
Spherical harmonic DC components
Spherical harmonic AC components

In one embodiment, this sensitivity order is used to help design the groups to be made for coding of 3DGS parameters. For example, the following groups G0 through G6 may be used.
G0: Location, x∈R³
G1: Rotation, r∈R⁴,
G2: Scale, s∈R³, and
   Opacity, α∈R.
G3: SH-DC, c_{d}∈R³, i.e, DC value of all channels
G4: SH-AC¹,

$${c}_{a}^{1} ∈ {R}^{9} ,$$

i.e, first 3 AC values of all channels
G5: SH-AC²,

$${c}_{a}^{2} ∈ {R}^{15} ,$$

i.e, first 5 AC values of all channels
G6: SH-AC³,

$${c}_{a}^{3} ∈ {R}^{21} ,$$

i.e, first 7 AC values of all channels

In an example embodiment, learning-based coding of group G0 is conducted via a learning-based point cloud geometry codec, and the coding of the remaining groups G1-G6 is performed via a learning-based point cloud attribute codec. In example embodiments, the coding of groups G1-G6 depends on the decoded group G0 containing Gaussian locations. Various embodiments may use different techniques for coding of the remaining groups as described below.

Further details of the embodiments are described with reference to the use of groups G0 through G6, but it should be understood that other possible groupings are contemplated within the scope of the present disclosure. In some embodiments, for example, color components are organized into sixteen (16) groups with only one spherical harmonic component from each color channel, making a total of nineteen (19) groups. In other embodiments, scale and opacity are organized in separate groups, which may result in a total of eight (8) groups.

### Example Encoding Method

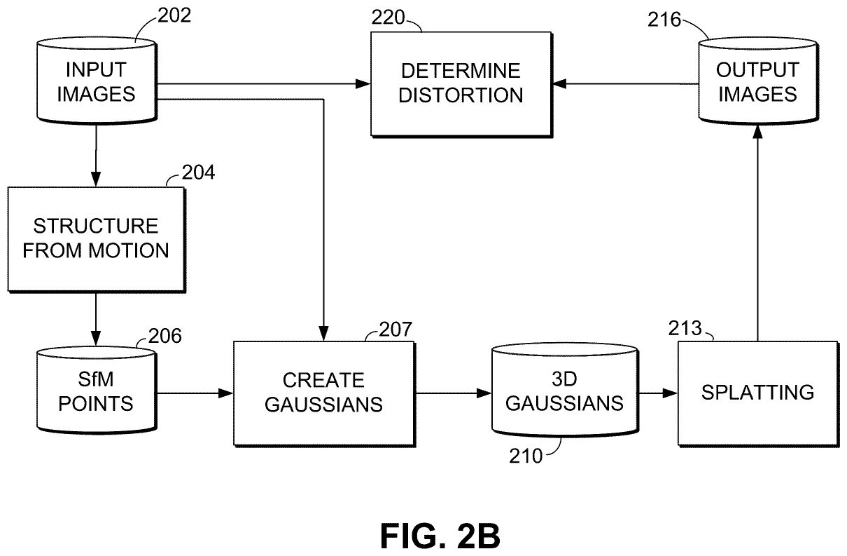

An overview of an example encoding method is illustrated in FIG. 3. In some embodiments, a grouping strategy is used to define groups within the 3DGS parameters and an intra-group dependency. This grouping and dependency information is also encoded into a bitstream via a group and dependency encoder so that the same information is also available to the decoder for corresponding operations.

Using the grouping, encoding of the defined groups is performed. In an example embodiment, the first group (G0), which is the location parameter group, is encoded before any other groups, and the encoding of the remaining groups is dependent on the locations of the Gaussians in 3DGS. As shown in the example of FIG. 3, the locations are encoded using a location encoder which can be any traditional or leaning-based point cloud geometry encoder.

After the coding of the location parameter group is complete, with the reconstructed location parameter group available on the encoder side, the encoding pipeline proceeds with the coding of the remaining groups. Since the reconstructed location parameter group is potentially different than the original location parameter group, a recoloring may be performed on the encoder side to map the original values of the remaining parameter groups to the reconstructed location parameters. This may be performed using a respective recolor module in the encoder. It should be noted that such a module is not required at the decoder side. The recolored remaining parameter groups are then coded in parallel or sequentially, incumbent upon the dependency order, via their respective encoder modules, as shown in the example FIG. 3. Here again, the respective encoder modules for each of the recolored remaining parameter groups can be traditional or learning-based point cloud attribute encoders.

The respective bitstreams representing all of the encoded groups, along with the group and dependency order bitstream, are sent to the multiplexer module “MUX” to pack everything into one bitstream.

As illustrated in FIG. 3, grouping of geometry and attribute information is performed at 302, with the groups being assigned as follows:
G0: Location vectors x
G1: Rotation matrices r
G2: Scale vectors s, and opacity values α
G3: DC spherical harmonic components c_{d}, with one DC value for each color channel
G4: Degree-one AC spherical harmonic components,

$${c}_{a}^{1} ,$$

representing the first three AC coefficients of each color channel (SH-AC¹)
G5: Degree-two AC spherical harmonic components,

$${c}_{a}^{2} ,$$

representing the next five AC values of each color channel (SH-AC²)
G6: Degree-three AC spherical harmonic components,

$${c}_{a}^{3} ,$$

representing next seven AC values of each color channel (SH-AC³)

A determination is made of which groups of attributes, if any, are to be encoded using a dependency on which other groups of attributes, and the result of the determination is encoded at 304. Information indicating which attributes are included in which groups may also be encoded at 304. These determinations may be made based on considerations of coding efficiency (e.g. more use of dependencies may result in a greater level of compression), considerations of processing power (more use of dependencies may call for greater processing power by the encoder and/or decoder), or on other considerations.

At 306, the location information x is encoded, and the encoded locations are reconstructed, giving reconstructed location information \hat{x}, which may differ from the input location information in the case of lossy coding.

An attribute transfer (or “recoloring”) process is performed to transfer attributes from the original input Gaussian positions to the positions given by the reconstructed location information \hat{x}. The attribute transfer process may be conducted by, for example, interpolating or applying a filter to attribute values associated with the input Gaussian positions according to various attribute transfer or recoloring techniques, which may be adapted from known point cloud recoloring techniques. Specifically, the recoloring process may be applied to the rotation information (at 308), the scale and opacity information (at 310), the DC spherical harmonic information (at 312), and the different orders of AC spherical harmonic information (at 314, 316, and 318).

In the example illustrated in FIG. 3, the determination of groups and dependencies (encoded at 304) is a determination to encode the attributes with a dependency only on the location information. Thus, with a dependency on the reconstructed location information \hat{x}, encoding is performed of the rotation (at 320), the scale and opacity (at 322), the DC spherical harmonic information (at 324), and the different orders of AC spherical harmonic information (at 326, 328, and 330). The encoded information is multiplexed into a bitstream BS at 332.

### Example Recoloring

As described above, in example embodiments, the encoder performs a recolor procedure on each parameter group (other than the location parameter group) to transfer the 3DGS parameters from the original Gaussian locations to the reconstructed Gaussian locations. The recoloring procedure is performed because the coded Gaussian locations typically undergo certain distortions, and these distortions can lead to the remaining parameters for the reconstructed Gaussian locations being undefined. After the reconstructed Gaussian locations are filled up by new parameters, they are sent to their respective encoder modules for encoding. In some embodiments, some or all of the recolor modules to perform the recoloring are traditional recoloring modules. In some embodiments, some or all of the recolor modules are learning-based modules that are trained to perform the recoloring.

It should be noted that a procedure of transferring attributes from original points to reconstructed points may be referred to herein as “recoloring” even where the attributes are attributes other than conventional color attributes, such as scaling and/or rotation attributes.

### Coding Dependency

It has been observed that there is in general little correlation between the spherical harmonic AC components that comprise G4, G5 and G6. Thus, in example embodiments, these AC components are coded independently from other AC component groups and independently of the other groups (G1, G2 and G3).

It has further been observed that there is in general little spatial correlation within the spherical harmonic AC components. Thus, in some embodiments, these SH-AC components are encoded via traditional coding technologies.

For the coding of the other remaining groups (G1, G2 and G3), in an example embodiment, they are coded independently of each other and only depending on the Gaussian locations (G0), as shown in FIG. 3. In such an embodiment, the coding dependency will be:
G1 will depend only on G0
G2 will depend only on G0
G3 will depend only on G0

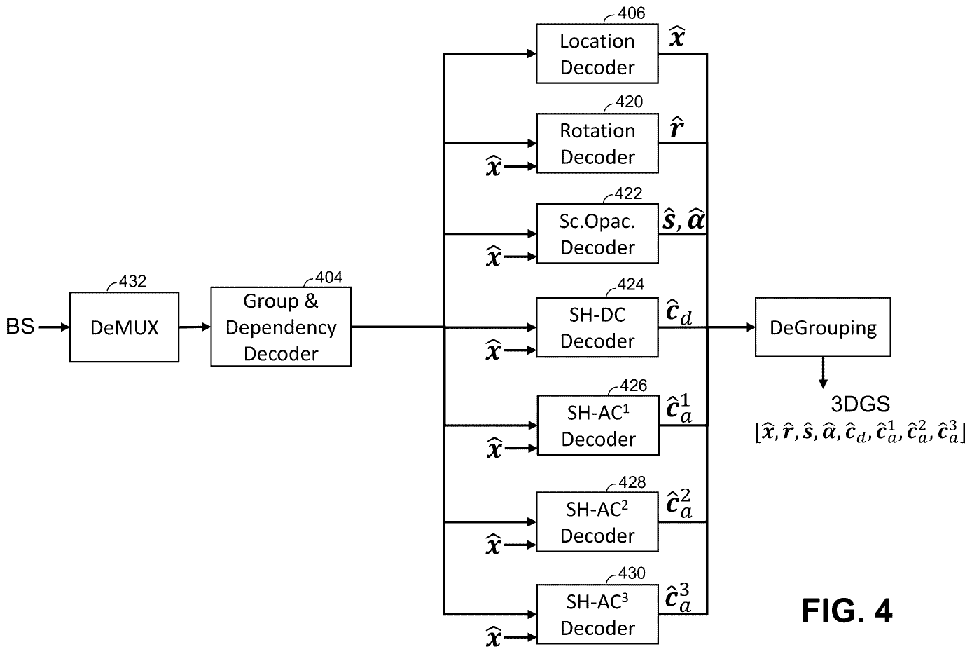

In another embodiment, for the coding of the other remaining groups (G1, G2 and G3), each group is coded dependent on the previous group and on the Gaussian locations (G0), as depicted in FIG. 5. In such an embodiment, the coding dependency will be:
G1 will depend only on G0
G2 will depend on G1 and G0
G3 will depend on G2 and G0

As illustrated in FIG. 5, the grouping is performed at 502 and the grouping and dependency is encoded at 504. At 506, the location information x is encoded, and the encoded locations are reconstructed, giving reconstructed location information \hat{x}, which may differ from the input location information in the case of lossy coding.

An attribute transfer (or “recoloring”) process is performed to transfer attributes from the original input Gaussian positions to the positions given by the reconstructed location information \hat{x}. Specifically, the recoloring process may be applied to the rotation information (at 508), the scale and opacity information (at 510), the DC spherical harmonic information (at 512), and the different orders of AC spherical harmonic information (at 514, 516, and 518).

Encoding is performed of the rotation (at 520) with a dependency on the reconstructed location information \hat{x}, and the encoded rotation information is reconstructed to obtain reconstructed rotation information \hat{r}. The scale and opacity are encoded (at 522), with a dependency on both the reconstructed location information \hat{x} and the reconstructed rotation information \hat{r}, according to the dependencies as encoded at 504. The encoded scale and opacity information are reconstructed to obtain reconstructed scale information ŝ and reconstructed opacity information â. The DC spherical harmonic information is encoded (at 524) with dependencies on the reconstructed scale information ŝ, the reconstructed opacity information a, and the reconstructed location information \hat{x}, according to the dependencies as encoded at 504. The different orders of AC spherical harmonic information are encoded (at 526, 528, and 530) with a dependency on the reconstructed location information \hat{x}. The encoded information is multiplexed into a bitstream BS at 532.

In yet another embodiment, for the coding of the other remaining groups (G1, G2 and G3), each group is coded dependent on all previous groups and on the Gaussian locations (G0). In such an embodiment, the coding dependencies will be:
G1 will depend only on G0
G2 will depend on G1 and G0
G3 will depend on G2, G1 and G0

### Example Decoding Method

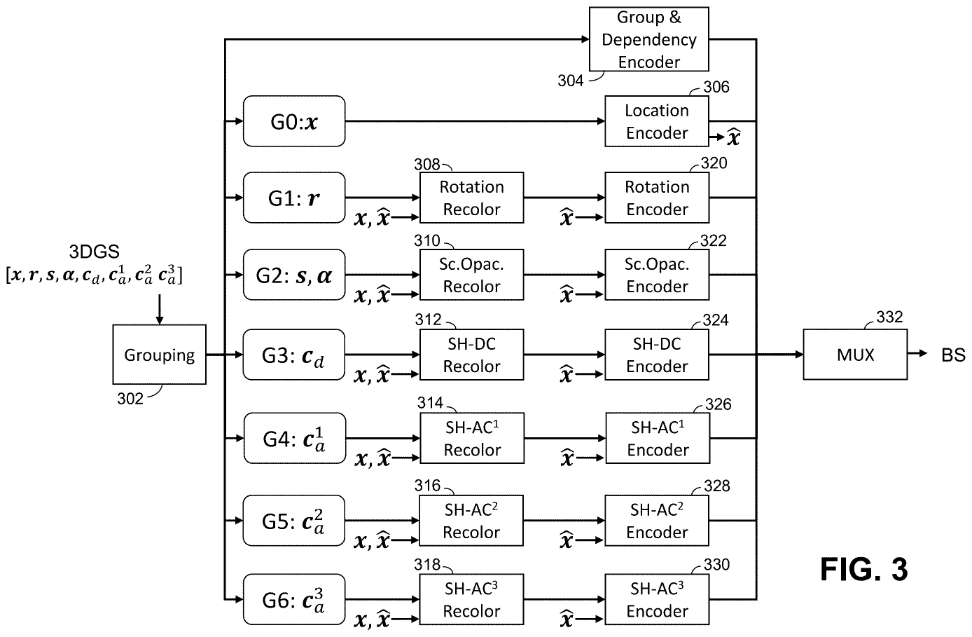

In an example embodiment, the decoding pipeline may be summarized as a mirror image of the encoding pipeline, as shown in the example of FIG. 4, where a demultiplexer module DeMUX produces the component bitstreams at 432. The group and dependency decoder decodes the grouping information and the dependency order between the groups at 404, where the location parameter group may be the first group to be decoded. As shown in the example FIG. 4, the locations are decoded at 406 via the location decoder which can be any traditional or leaning-based point cloud geometry decoder, corresponding to the encoder from the encoding pipeline.

After the decoding of at least a relevant portion of the location parameter group, with the reconstructed location parameter group available on the decoder side, the decoding pipeline proceeds with the decoding of the remaining groups. The remaining parameter groups are then decoded in parallel or sequentially, incumbent upon the decoded dependency order, via their respective decoder modules, as shown in the example of FIG. 4. Specifically, decoding is performed of rotation information (at 420), scale and opacity information (at 422), the DC spherical harmonic information (at 424), and the different orders of AC spherical harmonic information (at 426, 428, and 430), all of which may be decoded with a dependency on the reconstructed location information \hat{x}, according to the dependencies as decoded at 404.

Here again, the respective decoder modules for each of the recolored remaining parameter groups can be traditional or learning-based point cloud attribute decoders, corresponding to the encoder from the encoding pipeline.

Once the decoding of all groups is finished, the decoded group information is organized back into a final 3DGS output.

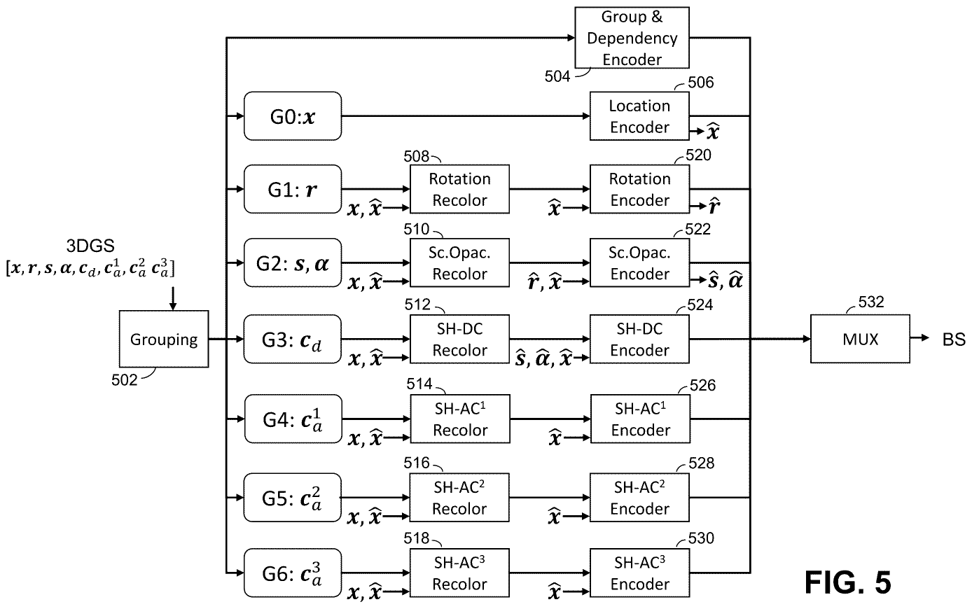

Another example of a decoding pipeline is depicted in FIG. 6, in which the decoding dependency order corresponds to the encoding dependency order from FIG. 5, in that each group (except for the groups for SH-AC) are dependent on the previous group and on the location parameter group.

In the example of FIG. 6, where a demultiplexer module DeMUX to produces the component bitstreams at 632. The group and dependency decoder decodes the grouping information and the dependency order between the groups at 604, where the location parameter group may be the first group to be decoded. As shown in the example FIG. 6, the locations are decoded at 606 via the location decoder which can be any traditional or leaning-based point cloud geometry decoder, corresponding to the encoder from the encoding pipeline.

After the decoding of at least a relevant portion of the location parameter group, with the reconstructed location parameter group available on the decoder side, the decoding pipeline proceeds with the decoding of the remaining groups. The remaining parameter groups are then decoded in parallel or sequentially, incumbent upon the decoded dependency order, via their respective decoder modules, as shown in the example of FIG. 6. Specifically, the rotation information is decoded at 620, with a dependency on the reconstructed location information \hat{x}, according to the dependencies as decoded at 604. The scale and opacity information is decoded at 622 with dependencies on reconstructed location information \hat{x} and the reconstructed rotation information \hat{r}, according to the dependencies as decoded at 604. The DC spherical harmonic information is decoded at 424, with dependencies on reconstructed location information \hat{x}, reconstructed opacity information â, and reconstructed scale information ŝ, according to the dependencies as decoded at 604. The different orders of AC spherical harmonic information are decoded (at 626, 628, and 630) with a dependency on the reconstructed location information \hat{x}. The decoded information is de-grouped at 634 and arranged into any appropriate format for 3DGS data.

### Conditional Coding

Example embodiments make use of conditional coding to implement the coding dependencies within a particular encoder module. In some embodiments, dependency on the previously coded groups is implemented through a learning-based conditional coding design. Conditional coding is described in U.S. patent application Ser. No. 18/814,402, entitled “An End-to-End Learning-Based Point Cloud Attribute Coding Framework,” filed Aug. 23, 2024, and U.S. patent application Ser. No. 18/830,310, entitled “An End-to-End Learning-Based Point Cloud Attribute Coding Framework,” filed Sep. 10, 2024, both of which are incorporated herein by reference in their entirety. Conditional coding is further described in the following publications:
Yung-Han Ho et al., “Conditional augmented normalizing flows for video compression,” European Conference on Computer Vision, 2022.
Theo Ladune et al., “Conditional coding for flexible learned video compression,” in Neural Compression: From Information Theory to Applications, arXiv:2104.07930, 2021.
Jerry Liu et al., “Conditional entropy coding for efficient video compression,” in European Conference on Computer Vision, pages 453-468, Springer, 2020, arXiv:2008.09180.
Ruihan Yang and Stephan Mandt, “Lossy image compression with conditional diffusion models,” arXiv:2209.06950, 2022.
Jianqiang Wang et al., “Dynamic Point Cloud Geometry Compression Using Multiscale Inter Conditional Coding,” arXiv:2301.12165, 2023.
Bowen Huang et al., “Temporal Conditional Coding for Dynamic Point Cloud Geometry Compression.” ICASSP 2024-2024 IEEE International Conference on Acoustics, Speech and Signal Processing (ICASSP), 2024.

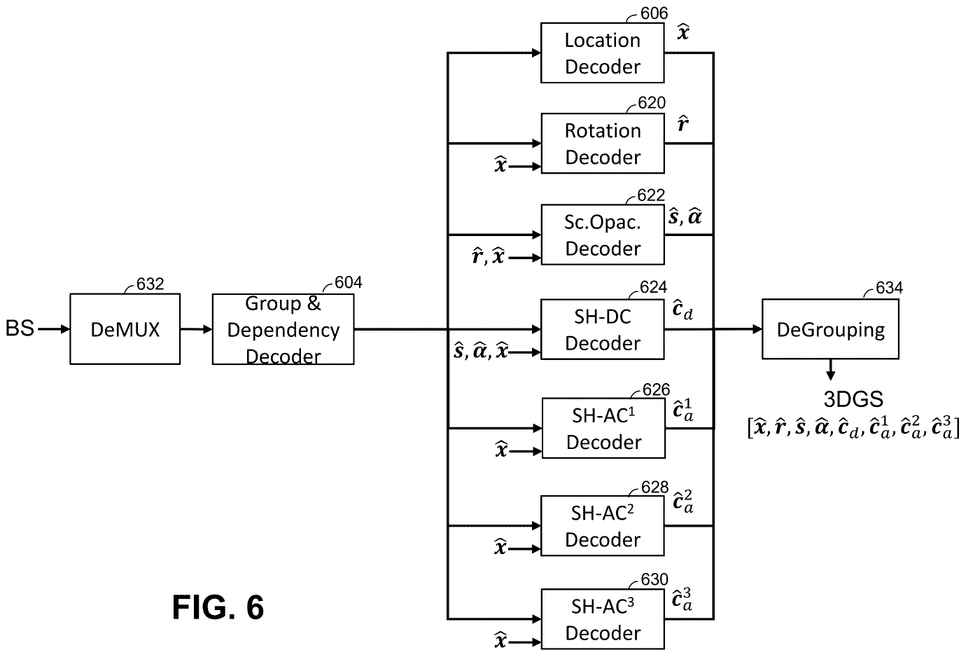

In an example implementation of conditional coding, the previously encoded parameter group or groups undergoes feature aggregation and is then provided to the conditional encoder as an additional conditional feature. The conditional encoder then aims to learn to eliminate the redundant information in the conditional inputs from the current parameter group to produce a residual feature that can be coded much more efficiently. An overview of this encoder design is presented in FIG. 7A.

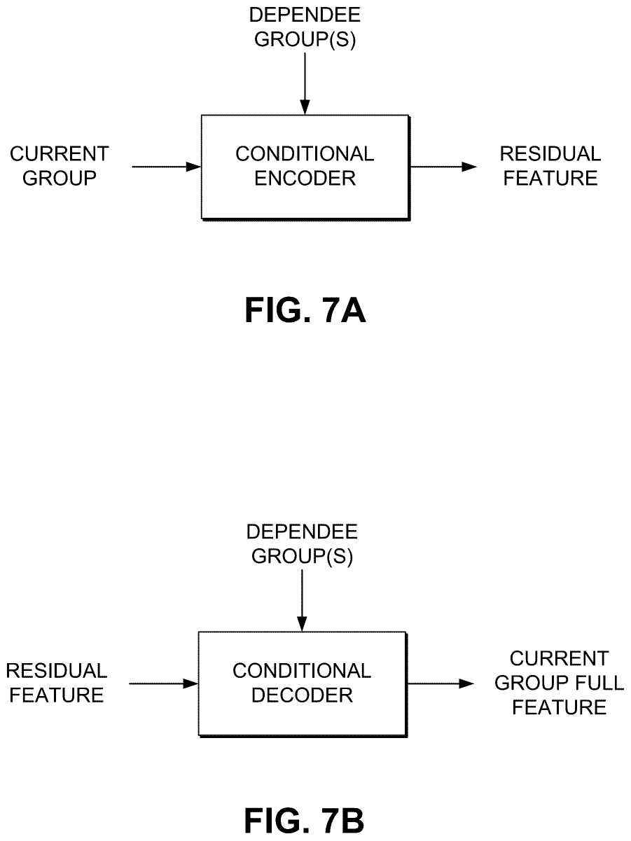

A specific example of this design for encoder in one embodiment is illustrated in FIG. 8A, for the case of when G2 is dependent on G1 and G0. The feature extracted from recolored G2 is concatenated with the features of dependee groups G1 and G0. The concatenated features are then aggregated to produce a residual feature for G2.

A corresponding conditional coding design is employed by the corresponding decoder modules as well, as shown in FIG. 7B. The previously decoded parameter group or groups go through some feature aggregation which is then provided to the conditional decoder as an additional conditional feature. The conditional decoder then aims to learn to incorporate the redundant information in the conditional inputs back into the residual feature to produce a full feature for reconstruction of the current parameter group.

A specific example of this design for a decoder in one embodiment is presented in FIG. 8B, for the case of when G2 is dependent on G1 and G0. The decoded G2 residual feature is concatenated with the features of dependee groups G1 and G0. The concatenated features are then aggregated to produce a full G2 feature.

In various other embodiments, any existing learning-based encoder/decoder pair can be implemented with the addition of the conditional feature to design an overall conditional coding design.

In some embodiments, coding dependencies may be used that do not necessarily employ learning-based coding. Traditional coding techniques may be used to identify and account for redundancies between different attributes or groups of attributes. As one example, if an encoder identifies a correlation between a first attribute and a second attribute (e.g. through principal component analysis), then the second attribute may be predicted as a function (e.g. a linear function) of the first attribute, and the encoder may encode a residual representing a difference between the actual and predicted values of the second attribute. In this way, the second attribute is coded with a dependency on the first attribute.

3D Gaussian Splatting is an emerging technology for novel view synthesis with relatively low computational cost. As described above, this disclosure provides an efficient way to code the 3DGS parameters. In the proposed encoding pipeline, grouping and dependency order are defined on the 3DGS parameters. This information, along with the parameter groups, is coded into a bitstream. The decoding pipeline first decodes the grouping and dependency order information, followed by decoding of the groups according to their dependencies. All the decoded groups are finally organized back into an output 3DGS representation.

### Example Methods

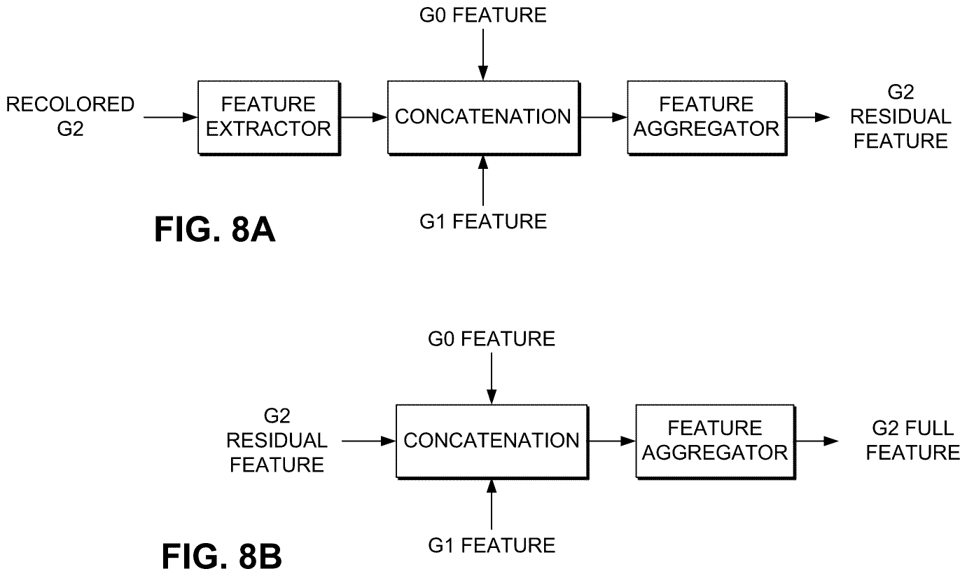

FIG. 9 is a flow diagram illustrating a decoding method according to some embodiments. 3D Gaussian splatting information is decoded from a bitstream including location information decoded at 902 and first attribute information decoded at 904. At 906, an indication of whether second attribute information was encoded with a dependency on the first attribute information is read from the bitstream. At 908, the second attribute information is decoded from the bitstream according to the determination. In some embodiments, the second attribute information is decoded with a dependency on the location information.

In some embodiments, the first attribute is in a first group of attributes, the second attribute is in a second group of attributes, and the indication is an indication of whether the second group of attributes was encoded with a dependency on the first group of attributes.

As non-limiting examples, in some embodiments, the first attribute is rotation information, and the second attribute is scale and/or opacity information. In some embodiments, the first attribute is scale and/or opacity information, and the second attribute is one or more coefficients of DC components of the spherical harmonics of the color channels.

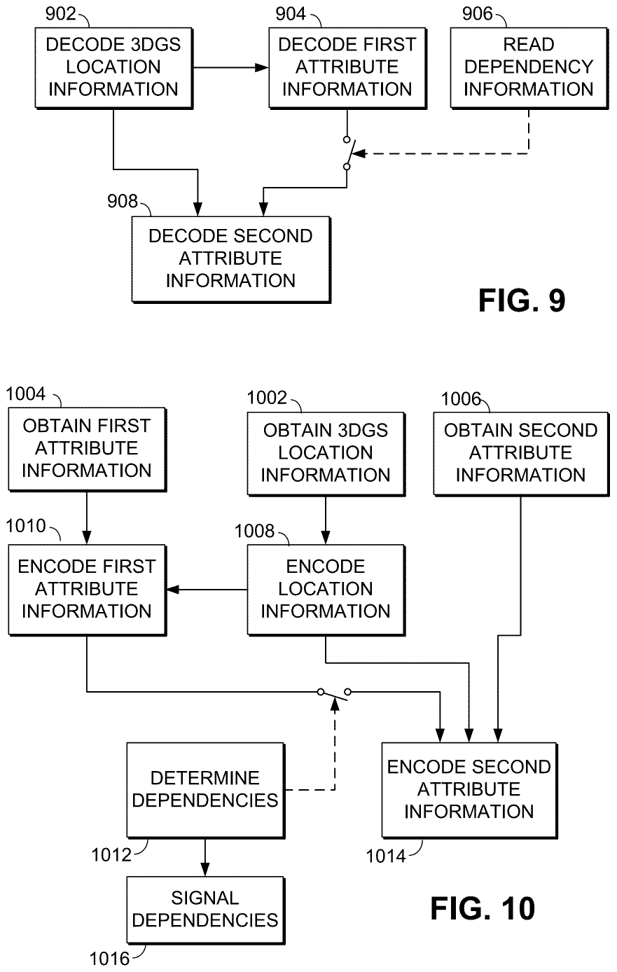

FIG. 10 is a flow diagram illustrating an encoding method according to some embodiments. An encoder obtains input 3D Gaussian splatting information, including obtaining location information at 1002, first attribute information at 1004, and second attribute information at 1006. The location information is encoded in a bitstream at 1008, and and the first attribute information is encoded in the bitstream at 1010 in a bitstream. At 1012, a determination is made of whether to encode the second attribute information with a dependency on the first attribute information. At 1014, the second attribute information is encoded in the bitstream according to the determination. At 1016, an indication of the result of the determination is signaled in the bitstream. In some embodiments, the second attribute information is encoded with a dependency on the location information.

In some embodiments, the first attribute is in a first group of attributes, the second attribute is in a second group of attributes, and the determination is a determination of whether to encode the second group of attributes with a dependency on the first group of attributes.

As non-limiting examples, in some embodiments, the first attribute is rotation information, and the second attribute is scale and/or opacity information. In some embodiments, the first attribute is scale and/or opacity information, and the second attribute is one or more coefficients of DC components of the spherical harmonics of the color channels.

Although the flow diagrams of FIGS. 9 and 10 expressly illustrate the processing of only two attributes, it should be understood that example embodiments include the processing of additional attributes (e.g. processing of all attributes). Where additional attributes are processed, the dependencies signaled in the bitstream may include information indicating coding dependencies of those other attributes as well. In some cases, some dependencies may not necessarily be signaled, for example it may be understood without signaling in some embodiments that all attributes are coded with a dependency on the location information, or it may be understood that some attributes (e.g. AC components) are not coded with a dependency on any other attribute (aside from the location information).

### Example Systems

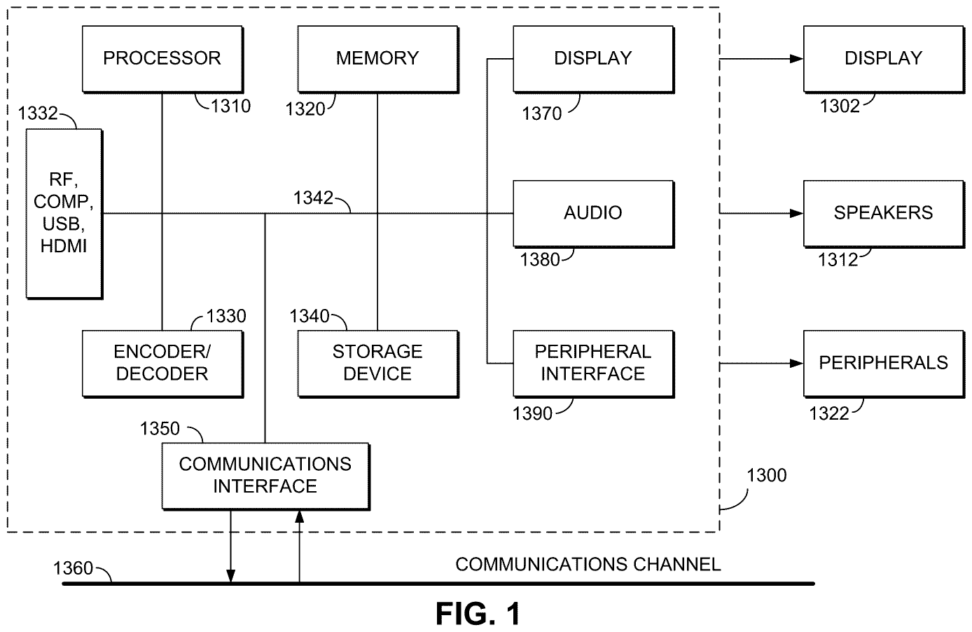

Some embodiments may be implemented on a system of one or more processors as illustrated in FIG. 1. FIG. 1 is a block diagram of an example of a system in which various aspects and embodiments are implemented. System 1300 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1300, singly or in combination, can be embodied in a single integrated circuit (IC), multiple ICs, and/or discrete components. For example, in at least one embodiment, the processing and encoder/decoder elements of system 1300 are distributed across multiple ICs and/or discrete components. In various embodiments, the system 1300 is communicatively coupled to one or more other systems, or other electronic devices, via, for example, a communications bus or through dedicated input and/or output ports. In various embodiments, the system 1300 is configured to implement one or more of the aspects described in this document.

The system 1300 includes at least one processor 1310 configured to execute instructions loaded therein for implementing, for example, the various aspects described in this document. Processor 1310 can include embedded memory, input output interface, and various other circuitries as known in the art. The system 1300 includes at least one memory 1320 (e.g., a volatile memory device, and/or a non-volatile memory device). System 1300 includes a storage device 1340, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1340 can include an internal storage device, an attached storage device (including detachable and non-detachable storage devices), and/or a network accessible storage device, as non-limiting examples.

System 1300 includes an encoder/decoder module 1330 configured, for example, to process data to provide an encoded video or decoded video, and the encoder/decoder module 1330 can include its own processor and memory. The encoder/decoder module 1330 represents module(s) that can be included in a device to perform the encoding and/or decoding functions. As is known, a device can include one or both of the encoding and decoding modules. Additionally, encoder/decoder module 1330 can be implemented as a separate element of system 1300 or can be incorporated within processor 1310 as a combination of hardware and software as known to those skilled in the art.

Program code to be loaded onto processor 1310 or encoder/decoder 1330 to perform the various aspects described in this document can be stored in storage device 1340 and subsequently loaded onto memory 1320 for execution by processor 1310. In accordance with various embodiments, one or more of processor 1310, memory 1320, storage device 1340, and encoder/decoder module 1330 can store one or more of various items during the performance of the processes described in this document. Such stored items can include, but are not limited to, the input point cloud, the decoded point cloud or portions of the decoded point cloud, the bitstream, matrices, variables, and intermediate or final results from the processing of equations, formulas, operations, and operational logic.

In some embodiments, memory inside of the processor 1310 and/or the encoder/decoder module 1330 is used to store instructions and to provide working memory for processing that is needed during encoding or decoding. In other embodiments, however, a memory external to the processing device (for example, the processing device can be either the processor 1310 or the encoder/decoder module 1330) is used for one or more of these functions. The external memory can be the memory 1320 and/or the storage device 1340, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1300 can be provided through various input devices as indicated in block 1332. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples include composite video.

In various embodiments, the input devices of block 1332 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1300 to other electronic devices across USB and/or HDMI connections. It is to be understood that various aspects of input processing, for example, Reed-Solomon error correction, can be implemented, for example, within a separate input processing IC or within processor 1310 as necessary. Similarly, aspects of USB or HDMI interface processing can be implemented within separate interface ICs or within processor 1310 as necessary. The demodulated, error corrected, and demultiplexed stream is provided to various processing elements, including, for example, processor 1310, and encoder/decoder 1330 operating in combination with the memory and storage elements to process the datastream as necessary for presentation on an output device.

Various elements of system 1300 can be provided within an integrated housing, Within the integrated housing, the various elements can be interconnected and transmit data therebetween using suitable connection arrangement 1342, for example, an internal bus as known in the art, including the Inter-IC (I2C) bus, wiring, and printed circuit boards.

The system 1300 includes communication interface 1350 that enables communication with other devices via communication channel 1360. The communication interface 1350 can include, but is not limited to, a transceiver configured to transmit and to receive data over communication channel 1360. The communication interface 1350 can include, but is not limited to, a modem or network card and the communication channel 1360 can be implemented, for example, within a wired and/or a wireless medium.

Data is streamed, or otherwise provided, to the system 1300, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1360 and the communications interface 1350 which are adapted for Wi-Fi communications. The communications channel 1360 of these embodiments is typically connected to an access point or router that provides access to external networks including the Internet for allowing streaming applications and other over-the-top communications. Other embodiments provide streamed data to the system 1300 using a set-top box that delivers the data over the HDMI connection of the input block 1332. Still other embodiments provide streamed data to the system 1300 using the RF connection of the input block 1332. As indicated above, various embodiments provide data in a non-streaming manner. Additionally, various embodiments use wireless networks other than Wi-Fi, for example a cellular network or a Bluetooth network.

The system 1300 can provide an output signal to various output devices, including a display 1302, speakers 1312, and other peripheral devices 1322. The display 1302 of various embodiments includes one or more of, for example, a touchscreen display, an organic light-emitting diode (OLED) display, a curved display, and/or a foldable display. The display 1302 can be for a television, a tablet, a laptop, a cell phone (mobile phone), or other device. The display 1302 can also be integrated with other components (for example, as in a smart phone), or separate (for example, an external monitor for a laptop). The other peripheral devices 1322 include, in various examples of embodiments, one or more of a stand-alone digital video disc (or digital versatile disc) (DVR, for both terms), a disk player, a stereo system, and/or a lighting system. Various embodiments use one or more peripheral devices 1322 that provide a function based on the output of the system 1300. For example, a disk player performs the function of playing the output of the system 1300.

In various embodiments, control signals are communicated between the system 1300 and the display 1302, speakers 1312, or other peripheral devices 1322 using signaling such as AV.Link, Consumer Electronics Control (CEC), or other communications protocols that enable device-to-device control with or without user intervention. The output devices can be communicatively coupled to system 1300 via dedicated connections through respective interfaces 1370, 1380, and 1390. Alternatively, the output devices can be connected to system 1300 using the communications channel 1360 via the communications interface 1350. The display 1302 and speakers 1312 can be integrated in a single unit with the other components of system 1300 in an electronic device such as, for example, a television. In various embodiments, the display interface 1370 includes a display driver, such as, for example, a timing controller (T Con) chip.

The display 1302 and speaker 1312 can alternatively be separate from one or more of the other components, for example, if the RF portion of input 1332 is part of a separate set-top box. In various embodiments in which the display 1302 and speakers 1312 are external components, the output signal can be provided via dedicated output connections, including, for example, HDMI ports, USB ports, or COMP outputs.

The embodiments can be carried out by computer software implemented by the processor 1310 or by hardware, or by a combination of hardware and software. As a non-limiting example, the embodiments can be implemented by one or more integrated circuits. The memory 1320 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1310 can be of any type appropriate to the technical environment, and can encompass one or more of microprocessors, general purpose computers, special purpose computers, and processors based on a multi-core architecture, as non-limiting examples.

### Further Embodiments

In some embodiments, a method of decoding 3DGS parameters comprises: accessing the grouping information of the 3DGS parameters and their dependency relationship from a bitstream, where the first group is location parameters of 3DGS; decoding the location parameter group of 3DGS; decoding remaining 3DGS parameter groups according to their specified dependency; and organizing the groups back into a full 3DGS representation for final output.

A method of encoding 3DGS parameters according to some embodiments comprises: encoding the grouping information of the 3DGS parameters and their dependency relationship into a bitstream, where the first group is location parameters of 3DGS; encoding the location parameter group of 3DGS; and encoding remaining 3DGS parameters groups according to their specified dependency.

A decoding method according to some embodiments comprises: decoding 3D Gaussian splatting information from a bitstream including location information and first attribute information; reading from the bitstream an indication of whether second attribute information was encoded with a dependency on the first attribute information; and decoding the second attribute information from the bitstream according to the determination.

In some embodiments, the second attribute information is decoded with a dependency on the location information.

In some embodiments, the first attribute is in a first group of attributes, the second attribute is in a second group of attributes, and the indication is an indication of whether the second group of attributes was encoded with a dependency on the first group of attributes.

In some embodiments, the first attribute information includes rotation information and the second attribute information includes scaling information.

In some embodiments, the first attribute information includes opacity information and the second attribute information includes spherical harmonic DC coefficient information.

Some embodiments further include: reading from the bitstream an indication of whether third attribute information was encoded with a dependency on the second attribute information; and decoding the third attribute information from the bitstream according to the determination.

A decoding apparatus according to some embodiments comprises one or more processors configured to perform any decoding method as described herein.

An encoding method according to some embodiments comprises: obtaining input 3D Gaussian splatting information including location information, first attribute information, and second attribute information; encoding the location information and the first attribute information in a bitstream; making a determination of whether to encode the second attribute information with a dependency on the first attribute information; encoding the second attribute information in the bitstream according to the determination; and signaling an indication of the result of the determination in the bitstream.

In some embodiments, the second attribute information is encoded with a dependency on the location information.

In some embodiments, the first attribute is in a first group of attributes, the second attribute is in a second group of attributes, and the determination is a determination of whether to encode the second group of attributes with a dependency on the first group of attributes.

In some embodiments, the first attribute information includes rotation information and the second attribute information includes scaling information.

In some embodiments, the first attribute information includes opacity information and the second attribute information includes spherical harmonic DC coefficient information.

An encoding apparatus according to some embodiments comprises one or more processors configured to perform any encoding method as described herein.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A decoding method comprising:
decoding 3D Gaussian splatting information from a bitstream including location information;
decoding first attribute information from the bitstream, the first attribute information being decoded with a dependency on the location information;
reading from the bitstream an indication of whether second attribute information was encoded with a dependency on the first attribute information; and
decoding the second attribute information from the bitstream according to the determination, the second attribute information being decoded with a dependency on the location information.

2. The method of claim 1, wherein the first attribute is in a first group of attributes, the second attribute is in a second group of attributes, and the indication is an indication of whether the second group of attributes was encoded with a dependency on the first group of attributes.

3. The method of claim 1, wherein the first attribute information includes rotation information and the second attribute information includes scaling information.

4. The method of claim 1, wherein the first attribute information includes rotation information and the second attribute information includes opacity information.

5. The method of claim 1, wherein the first attribute information includes opacity information and the second attribute information includes spherical harmonic DC coefficient information.

6. The method of claim 1, further comprising:
reading from the bitstream an indication of whether third attribute information was encoded with a dependency on the second attribute information; and
decoding the third attribute information from the bitstream according to the determination, the third attribute information being decoded with a dependency on the location information.

7. A decoding apparatus comprising one or more processors configured to perform at least:
decoding 3D Gaussian splatting information from a bitstream including location information;
decoding first attribute information from the bitstream, the first attribute information being decoded with a dependency on the location information;
reading from the bitstream an indication of whether second attribute information was encoded with a dependency on the first attribute information; and
decoding the second attribute information from the bitstream according to the determination, the second attribute information being decoded with a dependency on the location information.

8. The apparatus of claim 7, wherein the first attribute is in a first group of attributes, the second attribute is in a second group of attributes, and the indication is an indication of whether the second group of attributes was encoded with a dependency on the first group of attributes.

9. The apparatus of claim 7, wherein the first attribute information includes rotation information and the second attribute information includes opacity information.

10. The apparatus of claim 7, wherein the first attribute information includes rotation information and the second attribute information includes scaling information.

11. The apparatus of claim 7, wherein the first attribute information includes scaling information and the second attribute information includes spherical harmonic DC coefficient information.

12. The apparatus of claim 7, further comprising:
reading from the bitstream an indication of whether third attribute information was encoded with a dependency on the second attribute information; and
decoding the third attribute information from the bitstream according to the determination, the third attribute information being decoded with a dependency on the location information.

13. An encoding method comprising:
obtaining input 3D Gaussian splatting information including location information, first attribute information, and second attribute information;
encoding the location information in a bitstream;
encoding the first attribute information in the bitstream with a dependency on the location information;
making a determination of whether to encode the second attribute information with a dependency on the first attribute information;
encoding the second attribute information in the bitstream according to the determination, the second attribute information being encoded with a dependency on the location information; and
signaling an indication of the result of the determination in the bitstream.

14. The method of claim 13, wherein the first attribute is in a first group of attributes, the second attribute is in a second group of attributes, and the determination is a determination of whether to encode the second group of attributes with a dependency on the first group of attributes.

15. The method of claim 13, wherein the first attribute information includes rotation information and the second attribute information includes scaling information.

16. The method of claim 13, wherein the first attribute information includes rotation information and the second attribute information includes opacity information.

17. The method of claim 13, wherein the first attribute information includes opacity information and the second attribute information includes spherical harmonic DC coefficient information.

18. An encoding apparatus comprising one or more processors configured to perform at least:
obtaining input 3D Gaussian splatting information including location information, first attribute information, and second attribute information;
encoding the location information in a bitstream;
making a determination of whether to encode the second attribute information with a dependency on the first attribute information;
encoding the second attribute information in the bitstream according to the determination, the second attribute information being encoded with a dependency on the location information; and
signaling an indication of the result of the determination in the bitstream.

19. The apparatus of claim 18, wherein the first attribute information includes rotation information and the second attribute information includes opacity information or scaling information.

20. The apparatus of claim 18, wherein the first attribute is in a first group of attributes, the second attribute is in a second group of attributes, and the determination is a determination of whether to encode the second group of attributes with a dependency on the first group of attributes.
